(19) United States
(12) Patent Application Publication
(10) Pub. No.: US 2021/0287284 A1
(43) Pub. Date: Sep. 16, 2021

(54) METHOD, SYSTEM AND COMPUTER PROGRAM PRODUCT FOR PROCESSING SOCIAL DATA

(71) Applicant: BIONIC 8 ANALYTICS LTD., Hod Hasharon (IL)

(72) Inventors: Andrey OSTROVSKY, Petach-Tikva (IL); Kate NIR, Tel Aviv (IL)

(21) Appl. No.: 16/336,517

(22) PCT Filed: Sep. 25, 2017
(86) PCT No.: PCT/IL2017/051067

§ 371 Date: Mar. 26, 2019

Related U.S. Application Data
(60) Provisional application No. 62/399,514, filed on Sep. 26, 2016.

(51) Int. Cl. G06Q 40/02; G06Q 50/00; G06N 20/00

(52) U.S. Cl. CPC G06Q 40/025; G06N 20/00; G06Q 50/01

(57) ABSTRACT

A system, method and computer program product configured for generating predictions using social data and comprising assembling data, using a processor, from multiple sources, wherein at least one of the sources comprises social data; and combining the data including using a processor configured for comparing corresponding data provided by more than one of the multiple sources.

### REFERENCE TO CO-PENDING APPLICATIONS

Priority is claimed from U.S. Provisional Patent Application No. 62/399,514 entitled “Method and system for risk assessment . . . ” filed Sep. 26, 2016, the disclosure of which application is hereby incorporated by reference.

### FIELD OF THIS DISCLOSURE

The present invention relates generally to computerized systems and more particularly to computerized systems employing artificial intelligence.

### BACKGROUND FOR THIS DISCLOSURE

Conventional risk assessment analysis may include computing a score metric based on multiple evaluated variables (as relevant to the specific application and service itself) and applying the variable values to a pre-defined formula or score table (or score card). The computed score has a numerical value which may be used either to derive binary threshold decisions (e.g., safe/danger, approve/decline etc.) or to steer more complex e.g. multi-valued procedures and practices (e.g., set mortgage interest rate, security clearance level etc.). Regression or machine learning modeling may be involved in order to derive the scoring formula or improve a pre-existing one (e.g., by training). The modeling process may employ some or all of the retrieved information (variables) for training and acquisition purposes.

Risk assessment is a component of many applications and services in which a decision is required to be taken as a prerequisite or as a qualification step. For example, when evaluating candidates for one or more possible fork options e.g. to decide whether candidate ‘a’ is best suited to surgery or to physiotherapy, or to decide which candidates are most likely to benefit from a surgical intervention which is a scarce resource and may only be administered to some of many candidates, a preliminary evaluation process may be required to determine acceptance, or to set policy guidelines. Another example may involve employment suitability testing as part of a comprehensive recruiting process for, say, operating certain types of machinery which are characterized in that only some operators are successful in properly operating the equipment.

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

The term “social network” as used herein is intended to include any network which facilitates social interactions, typically through a dedicated website or application that enables individuals or groups to communicate with one another by posting data such as but not limited to information, comments, messages, images.

The term “social data” as used herein is intended to include data created by individuals and shared by the individuals, knowingly and voluntarily, with others, such as but not limited to data from a social network.

Certain embodiments seek to provide a processor configured, for each of a multiplicity of entities, to provide plural evaluations of an individual characteristic, such as but not limited to age or location, of an individual entity (e.g. human or group of humans) from among said multiplicity, the evaluations being respectively based on plural data items (e.g. declared, stated or inferred) accessed indirectly (e.g. by computational including logical derivation) or directly from at least one digital data source such as but not limited to a social network which may reside on any suitable computer network such as but not limited to the Internet, to compare the evaluations and to generate discrepancy scores accordingly; and to provide the discrepancy scores as an input to at least one decision making algorithm e.g. risk assessment algorithm.

Certain embodiments seek to provide an artificial intelligence/AI software tool that facilitates decision making, typically fully automated, optionally in real or near-real time, about individuals by providing data about individuals using publicly available data inter alia thereby to reduce decision making risk.

A particular advantage is that decision making is facilitated by reducing risk of considering disadvantaged individuals about whom little conventional data is available. For example, computerized financial institutions using the tool shown and described herein can consider accommodating individuals with little to no credit history because data on such individuals is thereby made available, such that risk-taking regarding such individuals is reduced.

Any suitable technologies may be used to identify, by searching, accumulating and combining publicly available, data e.g. from social networks, which may be combined with directly obtained human behavior indicators e.g. via declaration. Typically, the tool accommodates both individual and batch queries.

According to certain embodiments, individuals' reliability or credibility or stability are quantified and/or ranked, using any suitable cognitive computing algorithm or model which may be uniform or may be use-case specific or institution-specific (to the institution providing the queries).

According to certain embodiments, the tool gathers and processes data for provision to computerized services such as but not limited to online peer-to-peer services thereby to facilitate p2p operations and reduce risk thereof by allowing peers to evaluate one another.

Certain embodiments of the present invention seek to provide processing circuitry comprising at least one processor in communication with at least one memory, with instructions stored in such memory executed by the processor to provide functionalities which are described herein in detail. Any functionality described herein may be firmware-implemented or processor-implemented, as appropriate.

The present invention typically includes at least the following embodiments:

### Embodiment 1

A system or method for generating predictions using social data, the method or system comprising:

assembling data relevant to assessing a risk, from multiple sources, wherein at least one of the sources comprises social data; and

combining said data including comparing corresponding data provided by more than one of the multiple sources such as discrepancies in an individual or entity's age or location, as indicated by plural ones of said multiple sources.

### Embodiment 2

A system or method according to the preceding embodiment, wherein at least one of the sources comprises declared data from a declared source e.g. structured data e.g. an electronic form for filling out by an individual about whom data is being collected.

### Embodiment 3

A system or method according to any of the preceding embodiments, wherein at least one of the sources comprises a stated source.

### Embodiment 4

A system or method according to any of the preceding embodiments, wherein at least one of the sources comprises an inferred source.

### Embodiment 5

A system or method according to any of the preceding embodiments, wherein at least one of the sources comprises data derived from social network activity.

### Embodiment 6

A system or method according to any of the preceding embodiments, wherein at least one of the sources comprises data appearing on an individual's social network profile.

### Embodiment 7

A system or method according to any of the preceding embodiments e.g. embodiment 6, wherein said data derived from social network activity comprises an individual's age as derived from the individual's association with e.g. subscription to specific groups.

### Embodiment 8

A system or method according to any of the preceding embodiments, wherein each source contributes to assessment of the risk, both on its own and as compared to at least one other source.

### Embodiment 9

A system or method according to any of the preceding embodiments e.g. embodiment 8, wherein each source contributes to assessment of the risk, both on its own and as compared to each of the other sources.

### Embodiment 10

A system or method according to any of the preceding embodiments, wherein said assessment scales and/or weights the contribution of each source on its own.

### Embodiment 11

A system or method according to any of the preceding embodiments, wherein said assessment scales and/or weights the values of at least one source as compared to the other sources.

### Embodiment 12

A system or method according to any of the preceding embodiments, wherein said generating prediction comprises risk assessment.

### Embodiment 13

At least one processor configured to perform at least one of or any combination of the described operations or to execute any combination of the described modules.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or by a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices. Any reference to a computer, controller or processor is intended to include one or more hardware devices e.g. chips, which may be co-located or remote from one another.

The present invention may be described, merely for clarity, in terms of terminology specific to, or references to, particular programming languages, operating systems, browsers, system versions, individual products, protocols and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawing:

FIG. 1 is a simplified flowchart illustration of an example retrieve/compute process in accordance with an embodiment of the invention. The method of FIG. 1 typically comprises some or all of the illustrated operations, suitably ordered e.g. as shown.

Methods and systems included in the scope of the present invention may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Firmware implementing functionality described herein, if provided, may be held in any suitable memory device and a suitable processing unit (aka processor) may be configured for executing firmware code. Alternatively, certain embodiments described herein may be implemented partly or exclusively in hardware in which case some or all of the variables, parameters, and computations described herein may be in hardware.

Any module or functionality described herein may comprise a suitably configured hardware component or circuitry. Alternatively or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chips, which may be co-located or remote from one another.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

In the past years many individuals and companies have been using social networks and their presence in the social network sphere may be utilized to assess various risk factors for different scenarios. In this case, the computational aspects of the associated score involves the retrieval of various variables from the social network itself (of the individual or company—e.g., individual age, workplace, number of posts etc.) and processing the retrieved values by applying a pre-defined formula or score table as previously discussed.

For example, a typical risk-assessment scoring formula may maintain the following structure:

$$V = {\sum }_{i} {α}_{i} {x}_{i}$$

V—the numerical score
xᵢ—a variable which is part of the assessment process (e.g., age, number of posts, workplace)
α_{I}—a numerical value which is the variable weight (e.g., reflecting importance)
   The weights may be derived manually or by regression (e.g., fitting) or machine learning modeling (e.g., training).
   There are several problems with these solutions. Firstly, such solutions may force a formula based (or table based) methodology on retrieved information which may or may not possess direct numerical properties. Secondly, a process which mimics a score table procedure in which specific data elements need to be retrieved and summed up, is not sufficiently sensitive to the social network subtleties (as relevant for the risk assessment process of the examined individual or entity). In other words, trying to apply a “magic formula” which may, for example, multiply by some factor the individual's age and add to the resulting product, the individual's number of posts multiplied by some other factor, although may seem like a valid scoring formula candidate, is likely to miss real life actualities and their related risk impact. Since many risk assessment procedures involve score computations hence are not suitable for the case in which social networks are used as one or a sole or a principal source of information for an assessment process, certain embodiments seek to provide a system and method which, rather than as in certain conventional systems focusing solely on the face value of straightforward variables which influence the score, provided when handling information which involves social networks for risk assessment, acknowledges that variables may be retrieved in multiple ways such as but not limited to some or all of the following retrievals:
Declared: by the individual (e.g., credit application)
Stated: e.g. by the social network profile
Inferred: by the social network activities of the individual or entity which is under assessment. Inferred values may be deduced or computed based on the social network activity of the individual or entity. Examples:
   Determining age: Computing the average age, or any other central tendency or characteristic of age distributions, of an individual's friends or followers (or friend's friends, follower's followers, friends' followers, friends' friends' friends and other groups) of the individual within the social network
   Determining preferred geographical location: Identifying names of places in social network utterances by an individual and ranking these places as more or less preferred e.g. by counting the number of times each place appears in utterances.
While multiple source exists, a particular item of information e.g. age, may or may not exist by each of the sources.
Moreover, multiple sources for the same variable may report different values.
The difference in values may be quantified and accounted for.
The risk assessment formula may include both the weighted occurrences of each variable over all sources and the weighted differences if available over multiple sources.

Certain embodiments of the invention first redefine the variable categories for a risk assessment process which may be utilizing social networks information. Various variables may be retrieved and accessed in multiple ways, such as but not limited to all or any subset of the following:
Directly declared information by the entity (individual or company)—Note: This baseline information is willingly submitted by the entity (as part of an application process) and is not retrieved from social networks
Stated by the entity on its social network profile or as directly reflected by the entity's self actions within its social network (Note: This information may be retrieved from social networks)
Information which is inferred or deduced by the entity's social network activity in general (Note: This information may be retrieved from social networks). The inferred values are not available directly from the social network (as information from a stated profile) and a deduction process is required.
   For example, an individual which:
Declares his age on an electronic form e.g. an application to operate certain machinery, as 42.
Did not state his age on his social network profile.
His social network activities indicate an age group of 20-25 (e.g., based on natural language processing which yields certain characterizations of the individual e.g. her or his specific interests, which are pre-known to be associated pre-dominantly with a specific age-group
   Another example—an individual which:
Has missing information regarding home address on employment interview application
Declares current residence city on a social network profile (Denver, Colo.).
Social networks show geographical activity of the individual which greatly differs from the declared profile residence (San Diego, Calif.). (as previously noted system may observe the popularity of visited places which may indicate preferred locations)
Multiple information sources for the same variable may exist
Some information is numerical in nature (e.g., age) and other data elements are not (e.g., residence), and may even be missing. This may be resolved for example by look-up tables which translate non-numerical values to numerical values including missing values.
The predictive value of difference in value between multiple information sources for the same variable may be high, e.g. in the case of declared or stated sources as opposed to inferred sources.

As previously noted, classical risk assessment scoring formulas are not suitable for cases in which the assessment is based on social networks data. Certain embodiments of the invention take into account that when dealing with social data, certain variables may have multiple sources. While two sources exist in a direct way (either declared or stated), the third source may be derived indirectly from the individual's activity (or entity's activity) in the social network itself. As a previously explained example, the “age” of an individual may be derived by examining association with and subscription to specific groups.

Differences in values of the same variable (e.g., age), as retrieved from different sources, may have considerable predictive value. For example, these differences may be pre-determined (e.g. by machine learning, deep learning, regression techniques or any other suitable technology) to correlate with certain outcomes which it is desired to predict. Three (say) different sources may be distinguished and may be unique to the assessment process which is based on social data (the declared values, the stated values and the inferred values).

Any suitable linear or non-linear social based risk assessment scoring formula may be employed such as any or all of the addends of the following linear structure:

$$V = {\sum }_{i} {α}_{i} {f}_{i} ( {d}_{i} ) + {\sum }_{j} {β}_{j} {g}_{j} ( {s}_{j} ) + {\sum }_{k} {γ}_{k} {h}_{k} ( {r}_{k} ) + {\sum }_{l} {μ}_{l} {F}_{l} ( {d}_{l} , {s}_{l} ) + {\sum }_{m} {v}_{m} {G}_{m} ( {s}_{m} , {r}_{m} ) + {\sum }_{n} {ξ}_{n} {H}_{n} ( {s}_{n} , {r}_{n} )$$

### Explanation:

dᵢ—a declared variable value which as described above may be declared by the entity (e.g., individual, organization)
sᵢ—a stated variable value by the entity e.g. as retrieved from the entity's social network profile or as reflected by entity's direct self actions within its social network. For example, the number of friends an individual has, or the number of individuals which follow the individual who is being assessed, are variables which are not directly stated by the individual, but directly influenced by his/her social network actions, and may be assessed accordingly.
rᵢ—an inferred or deduced variable value associated with entity's social network activity
fᵢ(q), gᵢ(q), hᵢ(q)—single variable translation functions which are used either to scale a specific variable and its numerical value and/or to translate the non-numeric values into a numerical value.
   Examples:
      If the variable is “age” and required translation function should map age range to (0,1), then for example f(x)=1−e^{-x/40} may be suitable
      If the variable is “gender” then f(x) may comprise a binary output function (0 if x=‘male’ and 1 if x=‘female’)
      If the variable is “home-town” then F(x) may be a look-up-table in which different cities are given matching scores (“New York=132”) and if the information is either absent or no match exists in the look up table, then the returned value may be 0.
Fᵢ(u,v), Gᵢ(u,v), Hᵢ(u,v)—2-variable translation functions which are used to scale and compare values (either numerical or non-numerical) and provide a numerical metric output reflecting the difference of submitted variables and their existence
Examples:
   Let u be the declared age and v the stated age value. Then G(u,v)=e^{-|u-v|/10} provides a metric between 0 to 1 which reflects u,v resemblance (1 means equal and as the difference grows the value decreases to 0).
   Let u be the declared gender and v the stated gender values (or any other binary variable). Then H(u,v)=1 if both values are identical (male-male, female-female) or H(u,v)=−1 if values are different.
α_{I}, βⱼ, γₖ, μₗ, νₘ, →ξₙ—corresponding weights reflecting relative impact of a specific function output value. The weights may be zero (no impact on end score), positive (constructive impact on end score) or negative (destructive impact on end score). These weights may be determined in any suitable manner, such as but not limited to manual analysis, regression or machine learning. By manual analysis, this may be the case in which application-specific internal policy guidelines is translated into weighting certain inputs higher than other inputs. In the case of regression or machine learning, the corresponding weights may be computed based on a sample base history (for example, historical data of individuals which were accepted or rejected by the operation to date of a given decision making process).

Variable values may be derived from, say, all or any subset of three different sources—the declared source, the stated source and the inferred source. For example, information regarding the age of the individual may exist in the declared statement of the individual, the stated age as noted on its social profile, and by social network activity which may indicate an age group. Each source may contribute to the assessment evaluation three times—on its own and when compared individually to each of the other sources. The assessment formula may take into account not only the scaled and weighted value but the scaled and weighted differences of the values when compared to the other sources. It is appreciated that differences may be computed even within a particular type of source e.g. between plural declared sources, or between plural stated sources.

Each use case may have a separate weighting system. For example, when the system is used for a first risk assessment process and procedure/s, it may be desired to place a medium range weight on the declared age alone, ignore the stated age on the social profile and place a medium weight on difference between the declared age and inferred age information. For a second risk assessment process and procedure/s, it may be desired to place a high range weight on the declared age alone and on the stated age on the social profile and place a high weight on difference between the declared age and inferred age information. The weights may be derived either through a manual process or by existing regression and machine learning modeling techniques.

It is appreciated that any suitable technology may be employed for retrieving and accessing information (e.g. semantic data, geographic location data) of each particular type e.g. any suitable techniques known in the literature or available as open-source, sometimes depending on the network from which the data is being extracted. For “inferred” data, any suitable technology may be employed to collect and quantify raw data and to deduce “inferred values” from the raw data collected. According to certain embodiments, machine learning may be used in a set-up stage for example.

Declared information may be submitted by the user in any suitable manner e.g. via a suitable web service or mobile application or other electronic form. It is appreciated that any type of stated data may be directly accessed from the social network itself including data mined from social network profiles. This information may be accessed by any suitable technology e.g. conventional web requests e.g. HTTP requests. A social network itself may have a specific API (application program interface) via which the system herein may query information regarding individuals. To generate inferred information, typically, raw information is retrieved e.g. by collecting techniques as described, and predetermined logic then performs deduction to generate a result holding the inferred information. For example, information regarding a social network end user's age may be obtained from a form (declared), or from a social network profile (stated). Or, the individual's friends' ages, on the friends respective profiles, may be suitably combined e.g. by computing an average or other central tendency.

According to certain embodiments, any or all of the following may be provided:

Partner Server—to communicate between an organization platform and the system of the present invention. This server may communicate risk assessment requests to the system which may include identification parameters of the individual or entity (applicant) which is assessed.
Scoring Server—computes scores of the individuals and entities (applicants).
Collection Server—communicates with suitable open web elements for retrieving information useful for risk assessment scoring evaluation per individual and entities. May use any suitable conventional methods e.g. HTTP or other client-server communication techniques.
API Server—translates organization requests for risk assessment into specific processes to be addressed by the collection server and scoring server.
Any suitable process flow may be employed. For example, when an organization desires to risk assess the individual or entity (applicant), the organization may login to the API server and authenticate itself. The organization may then send the applicant information which may include basic applicant data as declared by the applicant (e.g., such as name, email, address, etc.).
After identification is established, then the scoring risk assessment analysis starts. Different web resources are reviewed. The score result is then computed and delivered back to the organization unless the system of the present invention is unable to compute a certain score e.g. due to, say, non-existing applicant, network failure.

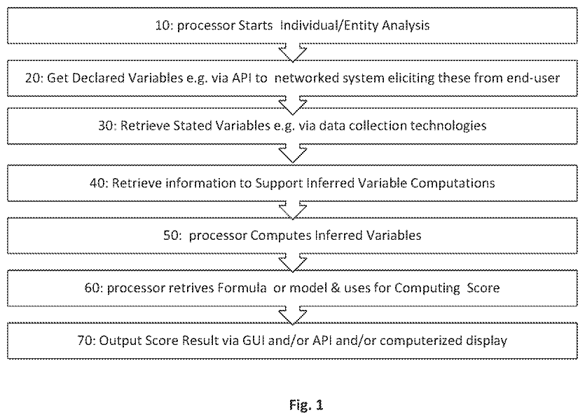

FIG. 1 is a simplified flowchart illustration of an example retrieve/compute process provided in accordance with an embodiment of the present invention; some or all of the operations may be provided, in any suitable order e.g. as shown.

Any suitable data-gathering methods known in the art may be used to perform operations 30 and/or 40 in FIG. 1, such as but not limited to any of the data collecting techniques as described in any of the following prior art publications or others:

“CS224 W: Social and Information Network Analysis, Autumn 2010”, available online at http://snap.stanford.edu/class/cs224w-2010/datasetsInfo.html

“Data Acquisition in Social Networks: Issues and Proposals” by Claudia Canali, Michele Colajanni, Riccardo Lancellotti, available online at https://pdfs.semanticscholar.org/ebbf/fbe487fadb0ee63e8c68a17f049d57c7da2d.pdf

the disclosures of which are hereby incorporated by reference.

It is appreciated that a particular advantage of certain embodiments is that peer-to-peer web services are enhanced; for example a system may be provided which enables its end-users to provide services to one another e.g. 3d printing services, including allowing an individual end-user, George, to evaluate the risk of providing “his” service to Mary vs. to Joan by assessing respective risks in selecting Mary vs. selecting Joan.

It is appreciated that according to certain embodiments, inferred variable computation in FIG. 1 includes generating group behavior and group dynamics parameters, inter alia, for at least some individuals including identifying certain individuals as central within certain groups of individuals and/or automatically identifying improprieties derived from group dynamics such as conflict of interest between an individual's leadership role (centrality) in group A and other known characteristics of the individual. For example, an individual may be identified as an early adaptor by comparing temporal or other aspects of his engagement with a given trend as evidenced by social data, with the rate of engagement of other individuals with the same trend. Then, organizational decision-making may use the early adopter identifications as inputs e.g. by prioritizing early adopters relative to later adopters for certain organizational operations, or vice versa.

It is appreciated that utility of the present invention includes risk assessment and/or prediction tasks including utility assessment (e.g. selecting an outcome that has the best expected value), longevity assessment, quality of service assessments when determining which entity e.g. peer, potential e-commerce merchant, individual or corporation is best to provide a technical or other service for which an individual end user may seek a provider, and so forth. For example, a person or organization known or deemed to be associated with a point of sale terminal may be evaluated according to certain embodiments herein, and a resulting evaluation score may be used as an input in decision-making software selecting one point of sale terminal via which to effect an e-transaction, from among several candidates.

It is appreciated that implementation of certain functionalities described herein in certain embodiments may be as a cellular app or as a smartphone SDK; as a hardware component; as an STK application, or as suitable combinations of any of the above.

The systems and methods shown and described herein are particularly useful in mining data repositories including hundreds, thousands, tens of thousands, or hundreds of thousands or millions or billions of data records, some unstructured and in natural language, regarding respective individual persons or organizations. This is because, practically speaking, such large bodies of knowledge can only be processed, analyzed, sorted, or searched using computerized technology.

It is appreciated that terminology such as “mandatory”, “required”, “need” and “must” refer to implementation choices made within the context of a particular implementation or application described herewithin for clarity and are not intended to be limiting since in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally including at least one of a decision, an action, a product, a service or any other information described herein that impacts, in a positive manner, a problem or objectives described herein; and (b) outputting the solution.

The system may, if desired, be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with, but external to, the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g. triggered only by determinations that x is true and never by determinations that x is false.

Features of the present invention, including operations, which are described in the context of separate embodiments, may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A method for generating predictions using social data, the method comprising:
assembling data, using a processor, from multiple sources, wherein at least one of the sources comprises social data; and
combining said data including using a processor configured for comparing corresponding data provided by more than one of the multiple sources.

2. A method according to claim 1 wherein at least one of the sources comprises declared data from a declared source, wherein the declared source comprises structured data about an individual, provided by the individual.

3. A method according to claim 1 wherein at least one of the sources comprises a stated source.

4. A method according to claim 1 wherein at least one of the sources comprises an inferred source.

5. A method according to claim 1 wherein at least one of the sources comprises data derived from a social network activity.

6. A method according to claim 1 wherein at least one of the sources comprises data appearing on an individual's social network profile.

7. A method according to claim 6, wherein said data derived from social network activity comprises an individual's age as derived from the individual's association with specific social network groups.

8. A method according to claim 1 wherein each source contributes to assessment of at least one risk, both on its own and as compared to at least one other source.

9. A method according to claim 8, wherein each source contributes to assessment of at least one risk, both on its own and as compared to each of the other sources.

10. A method according to claim 8 wherein said assessment scales and/or weights the contribution of each source on its own.

11. A method according to claim 8 wherein said assessment scales and/or weights the values of at least one source as compared to the other sources.

12. A method according to claim 1 wherein said generating prediction comprises risk assessment.

13. A computer program product, comprising a non-transitory tangible computer readable medium having computer readable program code embodied therein, said computer readable program code adapted to be executed to implement a method as above, said method comprising the following operations:
assembling data relevant to assessing a risk, from multiple sources, wherein at least one of the sources comprises social data; and
combining said data including comparing corresponding data provided by more than one of the multiple sources, including identifying discrepancies in at least one characteristic (e.g. age or location) of at least one individual or entity, as indicated by plural ones of said multiple sources.

14. A processor configured, for each of a multiplicity of entities, to provide plural evaluations of an individual characteristic of an individual entity from among said multiplicity, the evaluations being respectively based on plural data items accessed from at least one digital data source, to compare the evaluations and to generate, for said individual characteristic and entity, at least one discrepancy score accordingly; and to provide the at least one discrepancy score as an input to at least one decision making algorithm.

15. A processor according to claim 14 wherein the evaluations include a first evaluation based on a declared data item and a second evaluation based on a stated data item.

16. A processor according to claim 14 wherein the evaluations include a first evaluation based on a declared data item and a second evaluation based on an inferred data item.

17. A processor according to claim 14 wherein the evaluations include a first evaluation based on an inferred data item and a second evaluation based on a stated data item.

18. A method according to claim 1 wherein said combining comprises computing at least one discrepancy between plural ones of said multiple sources in at least one characteristic of at least one social network entity.

19. A method according to claim 18 and wherein said characteristic comprises at least one of: an individual's age; and a social network entity's location.

20. A method according to claim 7, wherein said data derived from social network activity comprises an individual's age as derived from the individual's subscription to specific social network groups.

21. A processor according to claim 14 wherein said decision making algorithm is configured to predict at least one outcome pre-known to be correlated with said at least one discrepancy score.

22. A product according to claim 13 wherein said method comprises pre-determining, for at least one outcome to be predicted for each of plural social network entities such as humans, existence of correlation between the outcome and at least one specific discrepancy in at least one characteristic of at least one social network entity, as indicated by plural ones of said multiple sources, and wherein said combining comprises identifying whether said specific discrepancy is present, for each of a population of social network entities.

23. A product according to claim 22 and wherein said pre-determining comprises employing at least one of machine learning, deep learning, statistical regression and neural networks to pre-determine existence of said correlation by learning from available data pertaining to a multiplicity of social network entities for which said outcome is known.

24. A product according to claim 22, wherein said outcome comprises defaulting on a loan or mortgage.

25. A product according to claim 22, wherein said outcome comprises commission of an act of fraud by a social network entity e.g. human.

26. A method according claim 12 wherein said risk assessment comprises computing a linear combination of functions of data provided by at least one of the multiple sources.

27. A method according to claim 26 wherein at least one of said functions comprises a unity function.

28. A method according to claim 26 wherein data provided by at least one source contributes to the linear combination assessment at least twice including on its own and when compared individually to at least one of the other sources.

29. A method according to claim 26 wherein assessment of at least one risk comprises combines functions of plural differences within plural sources of a single type.

30. A method according to claim 26 wherein at least first and second risks are assessed using the same given data and wherein assessment of the first and second risks applies first and second sets of weights, respectively, to said given data.
